(19) United States
(12) Patent Application Publication
(10) Pub. No.: US 2014/0305915 A1
(43) Pub. Date: Oct. 16, 2014

(54) HEAT TREATMENT APPARATUS

(71) Applicant: Hitachi High-Technologies Corporation, Tokyo (JP)

(72) Inventors: Masatoshi Miyake, Tokyo (JP); Hiromichi Kawasaki, Tokyo (JP); Ken'etsu Yokogawa, Tokyo (JP); Takashi Uemura, Tokyo (JP)

(73) Assignee: HITACHI HIGH-TECHNOLOGIES CORPORATION

(21) Appl. No.: 14/182,126

(22) Filed: Feb. 17, 2014

(30) Foreign Application Priority Data
Apr. 10, 2013 (JP) 2013-082111

(51) Int. Cl. H05H 1/46

(52) U.S. Cl. CPC H05H 1/46
USPC 219/121.52

(57) ABSTRACT

A heat treatment apparatus, for enabling stable plasma discharge, with preventing desorption of silicon from silicon carbonite suppressing an amount of discharge of thermions therefrom, comprises a treatment chamber for heating a heating sample therein, a plate-shaped upper electrode, being disposed in the treatment chamber, a plate-shaped lower electrode, facing to the upper electrode and for producing plasma between the upper electrode, and a gas supplying means for supplying a gas into the treatment chamber, wherein the upper electrode and the lower electrode are made of a base material of silicon carbonite, and each being covered by a carbon film around thereof.

### CLAIM OF PRIORITY

The present application claims priority from Japanese Patent Application No. 2013-082111 filed on Apr. 10, 2013 the content of which is hereby incorporated by reference into this application.

### BACKGROUND OF THE INVENTION

1. Field of the Invention

The present invention relates to a heat treatment apparatus with applying plasma therein.

2. Description of the Related Art

In recent years, it is expected to introduce a new material having a wide band gap, such as, silicon carbide (SiC), etc., as a material of substrate for a power semiconductor device. The SiC, being the wide band gap semiconductor, has physical properties superior to those of silicon (Si), such as, being high in dielectric breakdown electric field, high in saturation electron velocity, and high in thermal conductivity thereof. Because of being the material of high dielectric breakdown electric field, it enables thin-filming of an element and/or doping with high density, and therefore it is possible to produce an element with high breakdown voltage and low-resistance. Also, because the band gap is large, heat exciting electrons can be suppressed, and further because a capacity of heat radiation is large due to the high thermal conductivity thereof, a stable operation can be obtained under high temperature. Accordingly, if a SiC power semiconductor device can be achieved, a great increase of efficiency and high performances can be expected, in various kinds of power/electric equipment, such as, in power transmission/conversion, industrial power apparatuses, and home electrical appliances, etc.

Processes for manufacturing various kinds of power devices with applying SiC as the substrate are almost similar to those in case when applying Si as the substrate. However, as a process differing from those greatly can be listed up a heat treatment process. The heat treatment process means an activation annealing after ion implantation of impurities, which is conducted for the purpose of controlling conductivity of the substrate, as a representative one thereof. In case of the Si device, the activation annealing is conducted under the temperature from 800 to 1,200° C. On the other hand, in case of SiC, the temperature from 1,200 to 2,000° C. is necessary due to the properties or characteristics of that material.

An annealing apparatus for use of SiC, for heating a wafer by the plasma, which is generated through radio-frequency, is disclosed in the Japanese Patent Laid-Open No. 2012-059872.

### SUMMARY OF THE INVENTION

With such apparatus as described in the Japanese Patent Laid-Open No. 2012-059872, there can be expected an increase of heat efficiency, an increase of response to heating and/or cost lowering of expendables of furnace, etc., comparing to that of the conventional resistance heating furnace. Then, upon this heat treatment apparatus applying plasma therein, studies are made, from a viewpoint of stability thereof. The annealing apparatus disclosed in the Japanese Patent Laid-Open No. 2012-059872 makes heating through the plasma, which is generated between parallel plate electrodes by the radio-frequency. In this annealing apparatus, as the basic material of discharging electrodes is applied graphite, having a heat-resisting property and being able to suppress an amount of thermionic emission due to large work function thereof. With suppression of the thermionic emission, it is possible to suppress transition into arc discharge. In case of applying the graphite as the basic material, gasses are discharged due to the heating, and the electric discharge comes to be unstable. Also, in case where a reflection mirror is disposed within a processing chamber for obtaining high temperature, a reflectivity thereof is lowered down because of stain due to soot caused by the gasses from the graphite. As a countermeasure to that, before processing a sample, so-called degasification is conducted, i.e., discharging the gasses absorbed in the basic material of graphite, by hearing the graphite basic material while running an inert gas therein. With this degasification, the gasses discharging from the graphite basic material are reduced down when heating the sample, and therefore it is possible to reduce an amount of soot. However, as a result of further study in more details thereof by the inventors, the followings come to clear; i.e., it is difficult to prevent the soot from being generated, completely, with only the degasification, it is necessary to conduct the degasification, again, after cleaning the reflection mirror by breaking the vacuum, if the soot is generated once. Then, studies are made on applying SiC as the basic material, in the place of the graphite. In case of applying SiC as the discharging electrodes, there is no chance that the material of the electrodes results into a source of contamination when processing SiC as a body to be processed. Also, since a melting point thereof is 2,730° C., SiC is a material having a sufficient heat resistance under the temperature from 1,200 to 2,000° C., necessary for activation of SiC. Further, also since the work function dominating an amount of the thermionic emission is relatively large, it can be considered that amount of the thermionic emission be suppressed when the temperature is high. However, if applying SiC to the discharging electrodes, there is a concern about an adhesion of Si, which is separated from the surface of SiC when being heated up to high temperature, and generation of instability of electric discharge, as well.

An object according to the present invention is, therefore, to provide a heat treatment apparatus for preventing the silicon separating from the silicon carbide while suppressing an amount of the thermionic emission, and thereby enabling the plasma discharge with stability.

As an embodiment for accomplishing the object mentioned above, there is provided a heat treatment apparatus, comprising: a treatment chamber configured to heat a heating sample therein;

a first plate-shaped electrode (an upper electrode) disposed within the treatment chamber;

a second plate-shaped electrode (a lower electrode) facing to the first electrode and configured to generate plasma between the first electrode;

a radio-frequency power supply configured to supply radio-frequency power to the first electrode or the second electrode; and

a gas supplying unit configured to supply a gas into the treatment chamber,

wherein the first electrode and the second electrode are made of a first material (silicon carbonite),

the first material is a material of high melting point, which is covered with a second material (carbon), and

the second material is a material of high melting point having a larger work function than that of the first material.

According to the present invention, it is possible to provide a heat treatment apparatus for preventing the silicon separating from the silicon carbide while suppressing an amount of the thermionic emission, and thereby enabling the plasma discharge with stability.

### BRIEF DESCRIPTION OF THE DRAWINGS

The present invention will become fully understood from the detailed description given hereinafter and the accompanying drawings, wherein:

FIG. 1 is a fundamental structure view of a plasma heat treatment apparatus, according to an embodiment of the present invention;

FIG. 2 is an upper view of a heat treatment chamber of the plasma heat treatment apparatus, being seen along the cross-section A-A′ shown in FIG. 1; and

FIG. 3 is a cross-section view of electric discharge electrodes of the plasma heat treatment apparatus, according to the embodiment of the present invention.

### DETAILED DESCRIPTION OF THE PREFERRED EMBODIMENTS

The inventors of the present invention conduct a high-temperature heating process with applying SiC as the material of electrodes. As a result thereof, the followings can be seen; i.e., when the temperature of the electrodes comes up to 1,500° C., approximately, Si is separated from the surface of the SiC electrode, and thereby deteriorating the electrodes, and the Si separated adheres on other parts. Then, further studies are made on a method for preventing the separation of Si from the SiC basic material, it can be found that the separation of Si from the SiC surface be suppressed by covering the discharging electrodes, being made of the basic material of SiC, i.e., a material having high melting point, with a carbon film, i.e., a material having the high melting point, being larger than SiC in the work function thereof. Since the carbon film is high in the heat resistance, and has a relatively large work function, it is also possible to suppress the amount of thermionic emission therefrom. With those countermeasures, it is possible to avoid the deterioration of the electrodes and the re-adhesion of Si separated, even when applying SiC to the basic material of the discharging electrodes, and also possible to provide a heat treatment apparatus for enabling to suppress the transition into the arc discharge due to the thermionic emission.

Hereinafter, explanation will be given on an embodiment according to the present invention by referring to the attached drawings.

### Embodiment

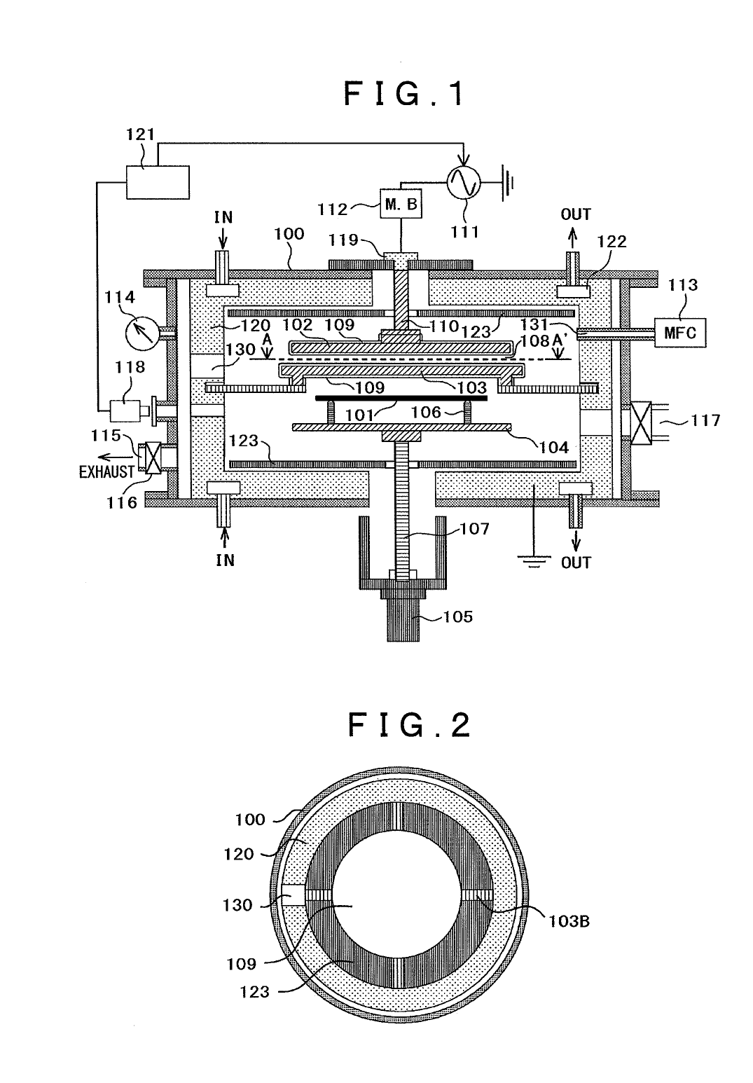

Explanation will be given on the embodiment according to the present invention, by referring to FIGS. 1 to 3. FIG. 1 is the fundamental structure view of the apparatus, applying the plasma therein. The present heat treatment apparatus comprises a heat treatment chamber 100 for heating a sample 101 to be heated (i.e., a body to be processed, and hereinafter, being called a “heating sample”), indirectly, by a lower electrode 103, which is heated by applying plasma generated between an upper electrode 102 and the lower electrode 103.

The heat treatment chamber 100 comprises the upper electrode 102, the lower electrode 103, as a heating plate arranged facing to the upper electrode 102, a sample stage 104 having supporting pins 106 for supporting the heating sample 101 thereon, a reflection mirror 120 for reflecting radiation heat, a radio-frequency power supply 111 for supplying a radio-frequency power for generating plasma to the upper electrode 102, a gas introduction means 113 for supplying a gas within the heat treatment chamber 100, and a vacuum valve 116 for adjusting pressure within the heat treatment chamber 100. A reference numeral 117 denotes a transfer port for transporting the heating sample therethrough. Further, the radio-frequency power for generating the plasma may be supplied to the lower electrode. In each of the drawings, the same reference numerals denote the same constituent elements.

The heating sample 101 is supported on supporting pins 106 of the sample stage 104, and comes close to a lower portion of the lower electrode 103. Also, the lower electrode 103 is supported by the reflection mirror 120, but not in contact with the heating sample 101 and the sample stage 104. In the present embodiment, as the heating sample 101 is used a SiC substrate of 4 inches (φ100 mm). Diameter and thickness of the upper electrode 102 and the sample stage 104 are determined to 120 mm and 5 mm, respectively.

About the lower electrode, explanation will be given by refereeing to FIG. 2. An upper view along the cross-section A-A′ in FIG. 1 is shown in FIG. 2. The lower electrode 103 comprises a disc-shaped member 103A, and 4 pieces of beams 103B, being disposed at an equal distance therebetween, and for connecting the disc-shaped member 103A mentioned above and the reflection mirror 120. Thickness of the lower electrode 103 is determined to 2 mm. The number, a cross-section area and the thickness of the beams 103B mentioned above may be determined by taking the strength of the lower electrode 103 and the heat radiation from the lower electrode 103 to the reflection mirror 120 into the consideration thereof. Also, the lower electrode 103 is provided in an upper part of the heating sample 101. Because of the structure of not covering over a side surface of the heating sample 101, the surface area of the lower electrode 103 can be made small, and therefore it is possible to reduce the heat radiation from the lower electrode. A member having an inner cylindrical shape may be disposed on a lower side of the lower electrode 103 (i.e., an opposite side to the surface facing to the upper electrode 102), in such a manner that it covers the side surface of the heating sample 101. In this case, although heat radiation becomes large, radiating from the lower electrode including that member having the inner cylindrical shape, but it is possible to reduce the heat radiation from the heating sample.

The lower electrode 103, because of such structure having the beams 103B as shown in FIG. 2, can suppress heat transfer of the heat of the lower electrode 103, which is heated by the plasma, to the reflection mirror 120, comparing to the case where all around of peripheries of the disc-shaped lower electrode is in contact with, directly, on the reflection mirror 120, and therefore, it works as a heating plate having high heat efficiency. The plasma generated between the upper electrode 102 and the lower electrode 103 is diffused from a space defined between the beams towards the vacuum valve 116; but the lower electrode 103 is larger than the upper electrode 102 and a pent roof is formed on the heating sample 101, therefore there is no chance that the heating sample 101 be exposed to the plasma.

Also, as the upper electrode 102, the lower electrode 103 and also the supporting pins 106 are applied those, each of which is covered with a carbon film formed through chemical vapor deposition (i.e., a CVD method) on the SiC substrate. Also, as the sample stage 104 is applied a graphite base material thereto. It is preferable that the carbon film formed through the CVD method, covering the SiC substrate, includes hydrogen therein, and that the thickness thereof is determined to be equal to or larger than the thickness sufficient for suppressing deposition of an element constructing the SiC substrate, and equal to or less than the thickness, at which a total amount of deposition of hydrogen comes to be lower than a permissible value thereof.

Also, a gap defined between the lower electrode 103 and the upper electrode 102 is determined to 0.8 mm. Further, the heating sample 101 has thickness from 0.5 mm to 0.8 mm, approximately, and each of the upper electrode 102 and the lower electrode 103 is machined to be tapered or round at a corner portion of round peripheries thereof, on the side facing to each other. This is for the purpose of suppressing localization of the plasma due to the concentration of electric field, at the corner portions of the upper electrode 102 and the lower electrode 103, respectively.

The sample stage 104 is connected with an up/down mechanism 105 through a shaft 107, and through an operation of the up/down mechanism 105, it is possible to deliver the heating sample 101, or to bring the heating sample 101 in the vicinity of the lower electrode 103. The details thereof will be mentioned later. Also, as the shaft 107, a material of alumina is applied thereto.

With the upper electrode 102 is supplied the radio-frequency power from the radio-frequency power supply 111, through an upper power feed line 110. In the present embodiment is applied the radio-frequency power at the frequency of 13.56 MHz. The lower electrode 103 is conducted with the reflection mirror 120 through the beams. Further, the lower electrode 103 is grounded through the reflection mirror 120. The upper power feed line 110 is also made of a composing material, i.e., SiC base material, being same to that of the upper electrode 102 and the lower electrode 103, and is covered with the carbon film thereon.

Between the radio-frequency power supply 111 and the upper electrode 102 is disposed a matching circuit 112 (“M.B” in FIG. 1 is an abbreviation of Matching Box), and thereby building up such construction that the radio-frequency power from the radio-frequency power supply 111 can be supplied to plasma formed between the upper electrode 102 and the lower electrode 103 at high efficiency.

In the heat treatment chamber 100, the upper electrode 102, the lower electrode 103 and the sample stage 104 are constructed to be surrounded by the reflection mirror 120. The reflection mirror 120 is made up through an optical grinding on an interior wall surface of a metal base material and plating or evaporation of gold on the grinded surface thereof. Also, a coolant flow path 122 is formed in the metal base material of the reflection mirror 120, and has such structure that the temperature of the reflection mirror 120 can be kept to be constant by running a cooling water therethrough. With provision of the reflection mirror 120, the radiation heats radiating from the upper electrode 102, the lower electrode 103 and the sample stage 104 can be reflected thereupon, and therefore, it is possible to increase the heat efficiency; however, this is not an essential structure according to the present invention.

Also, protection quartz plates 123 are disposed between the upper electrode 102 and the reflection mirror 120, and between the sample stage 104 and the reflection mirror 120.

The heat treatment chamber 100, in which the upper electrode 102 and the lower electrode 103 are disposed, has such structure that a gas can be introduced therein up to 10 atmospheres through the gas introduction means 113 and a gas introduction nozzle 131. The pressure of the gas to be introduced therein is monitored by a pressure detecting means 114. Also, the heat treatment chamber 100 can be discharged the gas therefrom, by an exhaust port 115 and a vacuum pump to be connected with the vacuum valve 116. A tip of the gas introduction nozzle 131 has a tapered shape, so that it has the structure for blasting the gas with force into a space or gap defined between the electrodes. The position of the gas introduction nozzle 131 is variable. Also, for the purpose of avoiding electric discharge between the upper electrode 102 and the gas introduction nozzle 131, it is preferable to apply an insulating body to be the gas introduction nozzle 131. In the present embodiment, alumina is applied to the gas introduction nozzle 131. Also, an inner exhaust port 130 is provided at the height between the upper electrode 102 and the lower electrode 103, and it is possible to discharge the gas between the electrodes with high efficiency, by reducing conductance defined from the gap between the upper and lower electrodes up to the inner exhaust port 130. With this, inert gases discharging from the respective electrodes are also can be discharged, quickly, without staying within the heat treatment chamber. Also, disposing the gas introduction nozzle 131 above the beams of the lower electrode 103 enables to suppress a flow of the gas introduced into a lower side of the lower electrode 103, and therefore it is possible to bring the gas to flow into the gap between the upper electrode 102 and the lower electrode 103 with high efficiency. Further, by disposing the inner exhaust port 130 at the position facing to the gas introduction nozzle 131, it is possible to make replacement of the gas between the upper and lower electrodes easy.

In the present embodiment, He is applied as the gas introduced into the heat treatment chamber 100. At a time-point when the gas pressure is stabilized in the heat treatment chamber 100, the radio-frequency power from the radio-frequency power supply 111 is supplied to the upper electrode 102 through the matching circuit 112 and a power introduction terminal 119, to generate the plasma within the gap 108, and thereby conducts the heating of the upper electrode 102 and the lower electrode 103. Energy of the radio-frequency power is absorbed into the electrons within the plasma, and further, due to collision of those electrons, atoms and/or molecules of the material gas are heated. Also, ions generating due to ionization are accelerated by the potential difference generating on sheaths on the surfaces of the upper electrode 102 and the lower electrode 103 contacting on the plasma, and they are incident upon the upper electrode 102 and the lower electrode 103 while colliding on the material gas. With this colliding process, it is possible to increase the temperature of the gas filled up within the gap defined between the upper electrode 102 and the lower electrode 103, and the temperature on the surfaces of the upper electrode 102 and the lower electrode 103 as well.

In particular, in such vicinity of the atmosphere, as is according to the present embodiment, ions collide on the material gas, frequently, when passing through the sheathes, and it can be considered that the material gas filled up in the gap defined between the upper electrode 102 and the lower electrode 103 can be heated, effectively. As a result of this, the temperature of the electrodes are increased, and then a heat input to those electrodes and a heat loss from those electrodes are balanced with, and therefore, the temperatures of those electrodes come to be almost saturated.

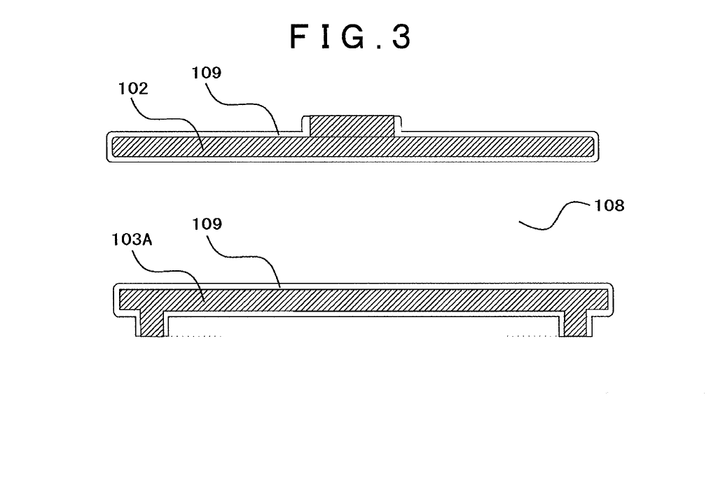

FIG. 3 shows the cross-section views of the upper electrode 102 and the lower electrode 103. SiC is applied as the material of the upper electrode 102 mentioned above. In the case where the heating sample 101 is made of SiC, there is no chance that the material of the main body of the electrode comes to be a source of contamination. Also, SiC has a very fine structure, so that there is no impurity gas absorbed within a balk of SiC nor possibility of discharging the impurity gas therefrom when it is heated. Also, the carbon film 109 having high melting point (i.e., the melting point being durable with use temperature) is covered on the surface of SiC. Thickness of the carbon film 109 mentioned above is determined at 5 μm, herein. With covering the surface of SiC with the carbon film 109, it is possible to suppress desorption of Si from the surface of SiC even when it is heated under high temperature. Also, the work function of the carbon film 109 is large; in general, it is possible to suppress an amount of discharge of thermions when it is heated under high temperature. The reason of this lies in that, as was mentioned previously, transition into the arc discharge relates to the discharge of thermions accompanying with an increase of temperature of the electrode, largely. Glow discharge is maintained by discharging of secondary electrons from the electrode; however, when an amount of discharge of the thermions from the electrode surface exceeds an amount of discharge of the secondary electrons, then the discharge is unstable and it transits into the arc discharge. The amount of discharge of the thermions from the electrode can be presented by the Richardson-Dushmann equation of the following equation (1); i.e., it is determined by the temperature and the work function of the carbon film 109 covering the surface of the electrode.

$${I}_{th} = \frac{4 π {mk}^{2} e}{{h}^{3}} {T}^{2} exp ( - \frac{φ}{kT} ) [ A \text{/} {m}^{2} ] \qquad ( 1 )$$

Where, “Ith” in the equation (1) presents an amount of discharge of thermions per a unit area, “m” a mass of electron, “k” the Boltzmann's constants, “e” a prime electric charge, “h” the Planck's constant, “T” absolute temperature of the electrode, and “φ” the work function of the electrode material, respectively. Accordingly, with applying the electrode material having large work function therein, even under the same temperature, it is possible to suppress the amount of discharge of thermions.

Also, for the carbon film 109, there are various kinds of films depending on combining condition thereof; a similar effect can be obtained by selecting any one among the followings; i.e., graphite (sp2 bonding), diamond-like carbon (sp2+sp3 bonding) and diamond (sp3 bonding). In the case of the diamond (sp3 bonding), although the band gap thereof is very large, i.e., 5.47 eV, but since it has a negative electro-negativity, the work function of the diamond is, in general, not so large as that of the graphite. Accordingly, it is preferable to apply or select the graphite (4.7 to 5.0 eV) having a large work function among the carbon films.

In the above, although the mentioning was made on the electrode structure of the upper electrode 102; for the 4 pieces of beams 103B for connecting the disc-shaped member 103A and the reflection mirror 120, as was mentioned above, which are disposed at an equal distance therebetween, it is also preferable that each electrode surface thereof is covered with the carbon film, while applying SiC as the material for the main body of the electrode, similar to that of the upper electrode 102.

The temperature of the lower electrode 103 or the sample stage 104 when conducting the heat treatment upon the heating sample is measured by a radiation temperature thermometer 118, and with applying this measured value, an output of the radio-frequency power supply 111 can be controlled so that it comes to a predetermined temperature by a controller 121; therefore, it is possible to control the temperature of the heating sample with high accuracy thereof. In the present embodiment, the radio-frequency power to be inputted is determined to 20 kW at the maximum.

For the purpose of increasing the temperatures of the upper electrode 102, the lower electrode 103, and the sample stage 104 (including the heating sample 101) with high efficiency, it is necessary to suppress the heat transfer of the upper power feed line 110, the heat transfer via He gas atmosphere and the radiation (i.e., of a frequency band from infrared lights to visible lights) from a high-temperature area. In particular, under the condition of high-temperature, an influence of heat loss through the radiation is very large, and therefore lowering the radiation loss is essential to increase the efficiency of heating. Further, the radiation loss increases an amount of radiation, in relation to fourth power of the absolute temperature.

In the present embodiment, the gap 108 between the upper electrode 102 and the lower electrode 103 is determined to 0.8 mm, for example, but the similar effect can be also obtained within a range from 0.1 mm to 2 mm. In case of the gap narrower than 0.1 mm, although the electric discharge can be generated, a function at high accuracy is needed for maintaining a degree of parallelization between the upper electrode 102 and the lower electrode 103. Also, changes in quality on the surfaces of the upper electrode 102 and the lower electrode 103 (for example, rough finishing, etc.), are not preferable since they give influences upon the plasma. On the other hand, if the gap 108 exceeds 2 mm, since it brings about a problem(s), such as, lowering ignitability of the plasma and/or increasing the radiation loss from the gap, this is not preferable.

In the present embodiment, pressure within the heat treatment chamber 100 is determined to 0.1 atmosphere for producing the plasma therein; the similar operation can be obtained under the pressure equal to 10 atmospheres or lower than that. In particular, preferable gas pressure lies from 0.01 atmosphere or higher than that, up to 0.1 atmosphere or lower than that. If the pressure becomes to be equal to 0.001 atmosphere or lower than that, the frequency of collision of ions upon the sheath portions is lowered, so that ions having large energy enter into the electrodes, then there is a possibility that the surfaces of the electrodes are spattered, etc. Also, in case where a range of the gap 108 defined between the upper electrode 102 and the lower electrode 103 lies from 0.1 mm to 2 mm, as was assumed in the present embodiment, this is also not preferable, because voltage for maintaining the discharge is increased under the gas pressure equal to 0.01 atmosphere or lower than that, due to the Paschen's law. On the other hand, when the pressure comes to be equal to 10 atmospheres or higher than that, since risks of generating abnormal discharges (i.e., unstable plasma and discharges other than between the upper electrode and the lower electrode) comes to be high, then it is undesirable. Also, in the present embodiment, the gas pressure is controlled by changing a gas flow rate; also the similar effect can be obtained through an adjustment of the gas pressure by changing an amount of the gas exhaust. It is of course that the pressure control may be achieved by changing both the gas flow rate and the amount of gas exhaust, simultaneously.

In the present embodiment, although He gas is applied as the raw material gas for use of producing the plasma, but it is needless to say that the similar effect can be obtained by applying a gas, i.e., an inert gas, such as, Ar, Xe, Kr, etc., other than that, as the main material thereof. Although He gas is superior in the ignitability of plasma and the stability in the vicinity of the atmospheric pressure; however, being high in the heat conductivity of the gas, and relatively large in the heat loss due to the heat transfer via the gas atmosphere. On the other hand, the gas having a large mass, such as, Ar, Xe, Kr gas, etc., for example, is low in the heat conductivity thereof, and then is advantageous than He gas, from a viewpoint of the heat efficiency thereof.

It is also needless to say that the carbon films 109, covering over SiC, as the base materials of the upper electrode 102 and the lower electrode 103, and the surfaces thereof, are preferable to be high in the purity thereof, from a viewpoint of preventing the contamination upon the heating sample 101.

Also, there are cases where the contamination upon the heating sample 101 is influenced, also from the upper power feed line 110 under the high-temperature. Then, according to the present embodiment, the upper power feed line 110 is also made of the base material of SiC, similar to that of the upper electrode 102 and the lower electrode 103, and the surface thereof is covered by the carbon film 109. Also, the heat on the upper electrode 102 transfers through the upper power feed line 110, and thereby becoming a loss. Therefore, it is necessary to stop or suppress the heat transferring from the upper power feed line 110 down to the minimum but to be necessary. Therefore, there is necessity of making an area of cross-section of the upper power feed line 110 made of graphite, as small as possible, and as long as possible in the length thereof. However, if making the area of cross-section of the upper power feed line 110 extremely small, and too long in the length thereof, then a loss of the radio-frequency power comes to be large, and this brings about lowering of heating efficiency of the heating sample 101. For this reason, according to the present embodiment, the area of cross-section of the upper power feed line 110 is determined to 12 mm², and the length thereof to 40 mm, from the viewpoint mentioned above. The similar effect can be also obtained within a range from 5 mm² to 30 mm² in the area of cross-section of the upper power feed line 110, and from 30 mm to 100 mm in the length of the upper power feed line 110.

Further, the heat of the sample stage 104 transfers though the shaft 107, and thereby resulting into the loss. Therefore, it is also necessary to suppress the heat transfer from the shaft 107 down to the minimum but to be necessary, similar to the upper power feed line 110. Therefore, it is also necessary to make the shaft 107 made of alumina as small as possible in the area of cross-section thereof, and as long as possible in the length thereof. In the present embodiment, the area of cross-section and the length of the shaft 107 made of alumina are determined to be the same to those of the upper power feed line 110 mentioned above, respectively, by taking the strength and the like thereof into the consideration.

In the present embodiment, as the radio-frequency power supply 111 for producing the plasma is applied the radio-frequency power supply of 13.56 MHz; this is because that power source can be obtained with a low cost, because 13.56 MHz is an industrial frequency, and a cost of the apparatus can be also reduced, because a standard for leakage of radio waves of that is low. However, in principle, it is needless to say that the heat treatment can be achieved with the similar principle, even with other frequencies. In particular, the frequencies equal to 1 MHz or higher than that and also equal to 100 MHz or lower than that are preferable. If the frequency is lower than 1 MHz, voltage of the high-frequency comes up to high when supplying the electricity necessary for the heating treatment, and abnormal discharges (i.e., unstable plasma and/or discharge other than between the upper electrode and the lower electrode) occurs; therefore, it is difficult to produce the stable plasma. Also, the frequency exceeding 100 MHz is also undesirable, because an impedance of the gap 108 defined between the upper electrode 102 and the lower electrode 103 is low, and it is difficult to obtain the voltage necessary for producing the plasma.

With the above-mentioned, it is possible, not only to lower the deterioration on the electrode surface and the desorption of impurity gas, etc., down to the minimum, but also to suppress the transition into the arc discharge due to the discharge of thermions, even when heating the heating sample with applying the plasma, and therefore, it is possible to provide the heat treatment apparatus for enabling discharge with stability.

The embodiments mentioned above are explained in the details thereof, for easy understanding of the present invention, and therefore, the present invention should not be restricted to those embodiments mentioned above; but may includes various variations thereof, and for example, it should not be limited, necessarily, only to that having all of the constituent elements explained in the above. Also, it is possible to add the constituent element(s) of other embodiment(s) to the constituent elements of a certain embodiment. Further, to/from/for a part of the constituent elements of each embodiment can be added/deleted/substituted other constituent element(s).

What is claimed is:

1. A heat treatment apparatus, comprising:
a treatment chamber configured to heat a heating sample therein;
a first plate-shaped electrode disposed within the treatment chamber;
a second plate-shaped electrode facing to the first electrode and configured to generate plasma between the first electrode;
a radio-frequency power supply configured to supply radio-frequency power to the first electrode or the second electrode; and
a gas supplying unit configured to supply a gas into the treatment chamber,
wherein the first electrode and the second electrode are made of a first material,
the first material is a material of high melting point, which is covered by a second material, and
the second material is a material of high melting point having a larger work function than that of the first material.

2. The heat treatment apparatus according to claim 1, wherein the second material is the material having a higher melting point than that of the first material.

3. The heat treatment apparatus according to claim 1,
wherein the second material includes hydrogens therein, and thickness thereof is equal to or greater than thickness for suppressing deposition of an element composing the first material and is equal to or less than thickness for bringing a total amount of deposition of hydrogens included in the second material to be equal to or less than a permissible value.

4. The heat treatment apparatus according to claim 1,
wherein the first material is silicon carbide, and the second material is carbon.

5. The heat treatment apparatus according to claim 4,
wherein composition of the carbon is at least one of graphite, diamond-like carbon and diamond.

6. The heat treatment apparatus according to claim 4, further comprising
a sample stage disposed below the second electrode and configured to mount the heating sample thereon,
wherein the radio-frequency power supply supplies the radio-frequency power to the first electrode, and composition of the carbon is graphite.

7. The heat treatment apparatus according to claim 1, wherein the second electrode is larger than the first electrode.

8. The heat treatment apparatus according to claim 1, wherein a reflection mirror is disposed within the treatment chamber in such a manner that it surrounds the first electrode and the second electrode.

9. The heat treatment apparatus according to claim 8, wherein the second electrode is held on the reflection mirror by beams.

10. The heat treatment apparatus according to claim 9, wherein each of the beams is made of a base material of silicon carbide and is covered with a carbon film.
